(19) United States
(12) Patent Application Publication
(10) Pub. No.: US 2010/0237023 A1
(43) Pub. Date: Sep. 23, 2010

(54) LIQUID TREATMENT APPARATUS AND METHODS

(75) Inventor: Allison Sprague, Prescott (CA)

Correspondence Address: WOOD, HERRON & EVANS, LLP, 2700 CAREW TOWER, 441 VINE STREET, CINCINNATI, OH, 45202, US

(73) Assignee: FLUID-QUIP, INC., Springfield, OH (US)

(21) Appl. No.: 12/789,952

(22) Filed: May 28, 2010

Related U.S. Application Data
(63) Continuation of application No. 11/553,791, filed on Oct. 27, 2006.

(51) Int. Cl. C02F 1/34; C02F 1/72

(52) U.S. Cl. 210/758; 210/150

(57) ABSTRACT

Apparatus and methods for treatment of liquids by generating hydroxyl radicals through the dissolution of water molecules by hydraulic cavitation.

### CROSS-REFERENCE TO RELATED APPLICATION

This application is a continuation of U.S. patent application Ser. No. 11/553,791, entitled “Liquid Treatment Apparatus and Methods,” filed Oct. 27, 2006 (pending), the contents of which are incorporated herein by reference

### FIELD OF THE INVENTION

The present invention relates to apparatus and methods for effecting the dissolution of water into hydroxyl radicals for the treatment of liquids.

### BACKGROUND OF THE INVENTION

Centrifugal separation of solids carried in a liquid-solid suspension by hydrocyclonic technology involves tangentially feeding the suspension into an open-ended, circular cylinder having an inwardly tapering inner diameter and extracting from its apex heavier solids, while collecting finer solids from its larger opposite end. Individual hydrocyclone cylinders may be relatively small—on the order of about four inches in length and with an inner diameter tapering from about a half inch to about a tenth of an inch—and are generally referred to as cyclonettes.

Typically, the cyclonettes are grouped in a housing, as shown in U.S. Pat. Nos. Re. 25,099; 3,261,467; 3,415,374; 3,486,618; 3,598,731; 3,959,123 and 5,388,708. As indicated by these patents, this technology dates back to at least the mid-1950's. Regardless, the essence of the technology is the same. A spiral flow of the suspension is introduced tangentially along the inwardly tapering inner wall of the cyclonette near its wider end and flows along the inner wall toward the opposite, smaller end. This generates a counter flow, which carries fines out the larger, open end.

In contrast to hydrocyclonic technology, hydraulic cavitation is directed toward the dissolution of water into hydroxyl radicals for the treatment of liquids. Early work in this field was directed to the generation of hydraulic cavitation by means of sound waves. See, for example, “The Chemical Effects of Ultrasound,” by Kenneth S. Suslick, Scientific American, February, 1989, pp. 80-86. However, hydraulic cavitation may also be induced by cavitating jets. See “Remediation and Disinfection of Water Using Jet Generated Cavitation,” by K. M. Kalumuck, et. al., Fifth International Symposium on Cavitation (CAV 2003) Osaka, Japan, Nov. 1-4, 2003.

Regardless of which cavitation method is employed, the goal is to generate many fine bubbles, which upon their implosion, create intense, but highly localized temperatures and pressures. This energy release then causes a dissolution of the water molecules and the creation of free hydroxyl radicals. The potential of these powerful radicals for the beneficial treatment of the water has been well recognized for many years.

For example, the patent literature discloses a multitude of methods and apparatus for this purpose. See, for example, U.S. Pat. No. 6,200,486, where fluid jet cavitation is employed for the decontamination of liquids by directing the flow along an interior chamber surface. Note also U.S. Pat. No. 6,221,260, which describes the creation of a central vortex about a longitudinal axis for inducing cavitation pockets in the vortex, and U.S. Pat. No. 6,896,819, which relies upon the formation of a liquid vortex along an inner surface of a cyclone.

Thus, it will be seen that the beneficial effects of cavitation are acknowledged and an understanding of the mechanism involved has been known for decades. However, the inefficiency of the known processes, whether based on ultrasonic or jet cavitation, has restricted commercial acceptance of hydraulic cavitation. There thus remains the apparent conundrum of a highly effective method of water treatment but at an energy cost that thwarts its widespread implementation.

### SUMMARY OF THE INVENTION

The present invention obviates the inefficiency of present day cavitation processes by employing liquid jets, but in a manner contrary to existing jet cavitation technology. Thus, while conventional wisdom focuses on the formation of hollow core jets to create shear zones that in turn generate cavitation, the present invention, in one embodiment, is directed to the formation of a central axial jet and a vacuum chamber that can be sealed by the exiting jet. Thus, in accordance with the present invention, cavitation is generated by directing a high velocity jet of fluid through a volume of vapor under a vacuum created in the chamber through which the jet travels.

In this embodiment, the present invention employs a high speed jet of liquid, flowing axially and concentrically through a cylindrical chamber to generate a vacuum within a confined space. The invention includes the provision of a liquid-free volume around the jet near the inlet end of the chamber to cause vapor to accumulate. The discharge opening of the chamber is designed so that it will be completely filled by the exiting jet of fluid, so as to seal the chamber and permit maintenance of a vacuum.

The present invention recognizes that although hydrocyclone technology is completely alien to hydraulic cavitation, conventional hydrocyclone apparatus may be modified and thus adapted for implementation of the present invention. For example, a conventional cyclonette may be employed to provide a central axial jet with its conventional, tangential feed opening blocked. Additionally, a multiplicity of cyclonettes may be mounted in a housing, essentially as shown in U.S. Pat. No. 5,388,708, but with the cyclonettes fed from the annular, outer chamber and discharging into the inner or central cylindrical chamber.

Alternatively, the tangentially directed inlet port in the cyclonettes of the '708 patent may be employed to inject a second stream of liquid into the cyclonette along its inside wall in a spiral flow path. Vapor within the cyclonette will tend to be dragged axially toward the discharge end by the linear jet and in a spiral path by the second liquid. When the two high-velocity liquid streams approach one another, the shear created due to the differences in velocity will tend to create a turbulent mixing zone that will disrupt the vapor film between the two liquids and generate bubbles. Increasing the fluid velocities will increase shear and reduce the size of the bubbles. It will also result in increased vacuum within the chamber and the generation of more vapor.

With this design cavitation initiates at very low inlet fluid pressure—on the order of 10 psi or less, with water at 30° C. and atmospheric pressure discharge. Also, the high shear generated helps reduce bubble size, which in turn, increases bubble surface to volume ratio and improves chemical reaction rates. As long as the velocity head of the fluid exiting the chamber exceeds the static pressure in the discharge zone, a vacuum will be generated within the chamber. Once pressure within the chamber drops to the vapor pressure of the liquid, vapor fills the cavity and cavitation occurs. Thus, the amount of vapor entrained is almost independent of pressure in the discharge zone.

As a modification of this embodiment, the main inlet jet may pass through a vortex finder of conventional design, except that, in addition to the flow being directed into the cyclonette from the vortex finder (instead of out of the cyclonette through the vortex finder), the vortex finder is modified to impart a spin to the incoming jet in a direction opposite to the direction of the tangential inlet flow. The result is that the collision of the two streams flowing in opposite directions creates a shear on the vapor trapped between the two streams that tears the vapor film into tiny bubbles, leading to increased cavitation efficiency.

In still a further modification of the basic embodiment of the invention, the enhancement of fine bubble generation may be attained by the interposition in the flow path into the cyclonette of a washer-shaped orifice plate. The abrupt decrease in diameter of the flow path through a modified vortex finder, not only accelerates flow and decreases pressure, but generates an intense shear zone that forms a virtual fog of tiny bubbles, the collapse of which, generates localized extreme temperatures and pressures.

### BRIEF DESCRIPTION OF THE DRAWINGS

FIG. 1 is an elevational view, partly in section, displaying an array of cyclonettes modified in accordance with the present invention, to generate hydraulic cavitation;

FIG. 2 is an elevational view of the extreme lower end of the device of FIG. 1 and with the cooperating inlet and outlet flow manifolds;

FIG. 3 is a cross-sectional view of a portion of FIG. 1 showing in greater detail the positioning of a modified cyclonette;

FIG. 4 is a horizontal view in cross-section taken along line 4-4 of FIG. 1;

FIG. 5 is a view similar to FIG. 4, but with portions removed to show more clearly the physical relationships of modified cyclonettes within an array with respect to each other;

FIG. 6 is an enlarged cross-sectional view of a cyclonette and vortex finder;

FIG. 7 is a view similar to FIG. 6, but showing a modified cyclonette and a modified vortex finder, together with an orifice plate;

FIG. 8 is a view similar to FIG. 7, but showing the flow of the liquid through the modified cyclonette, vortex finder and orifice plate;

FIG. 8A is a somewhat diagrammatic view of the liquid flow at point 8A in FIG. 8 and showing individual bubbles generated as the liquid flows through the inlet plate;

FIG. 8B is a view similar to FIG. 8A, but depicting the flow and bubbles at point 8B in FIG. 8 of the drawings;

FIG. 8C is a view similar to FIGS. 8A and 8B, but showing the individual bubbles somewhat dispersed at point 8C in FIG. 8 downstream of points 8A and 8B in FIG. 8;

FIG. 9 is a view similar to FIG. 6, but showing a modified flow path through the body of a cyclonette;

FIG. 10 is a view similar to FIG. 9, but with the extension of the vortex finder removed; and

FIG. 11 is a view similar to FIG. 7, but showing the orifice plate positioned downstream from the position shown in FIG. 7, closer to the throat area of the modified cyclonette.

### DESCRIPTION OF THE PREFERRED EMBODIMENTS

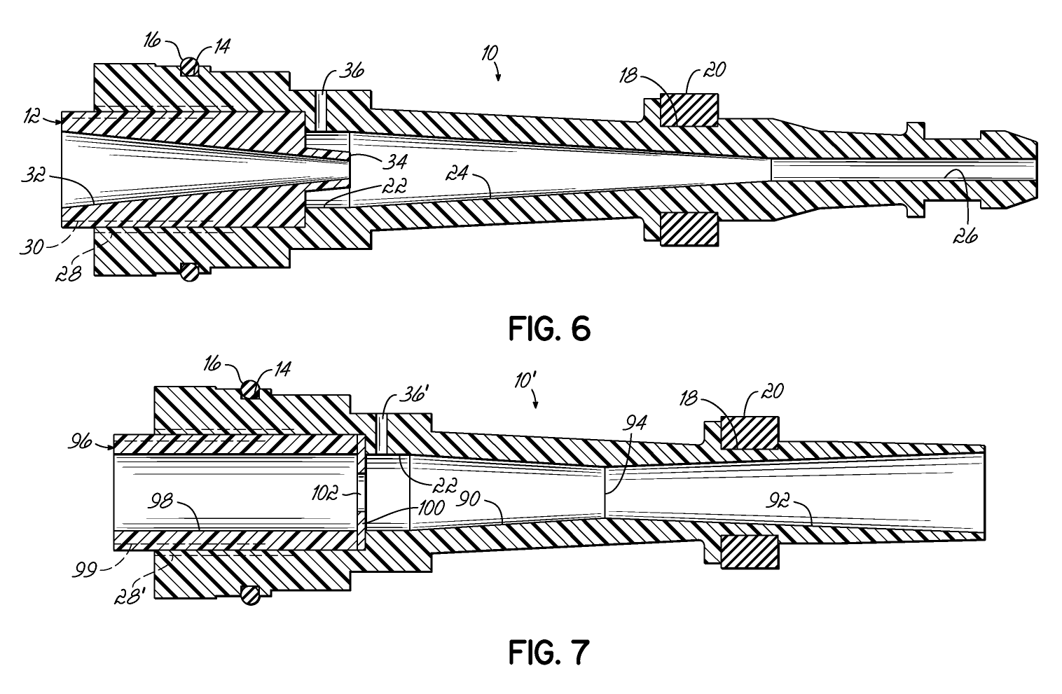

Turning initially to FIG. 6 of the drawings, a more or less conventional cyclonette 10 is shown with a vortex finder 12 installed in the left hand end of the cyclonette as it appears in FIG. 6 of the drawings. For a purpose to be presently described, the left-hand end of the cyclonette may be provided with an annular groove 14 into which an O-ring 16 may be seated. To the right of the O-ring 16, as seen in FIG. 6 of the drawings, a second annular groove 18 may be formed to receive a second O-ring 20 of more or less rectangular cross-sectional configuration. Interiorly of the cyclonette 10, a flow path is provided comprising a throat portion 22, an inwardly tapering flow channel 24, and a terminal flow channel 26 of narrower constant diameter. At its left-hand end, as seen in FIG. 6, the cyclonette 10 may be provided with an internally threaded socket 28 receiving the complementary external threads 30 of the vortex finder 12. The vortex finder has a uniformly inwardly tapering wall 32 and an extension 34 projecting into the throat portion 22 of the cyclonette. Lastly, the cyclonette may be provided with a passageway 36 extending through a wall of the cyclonette 10 into the throat section 22.

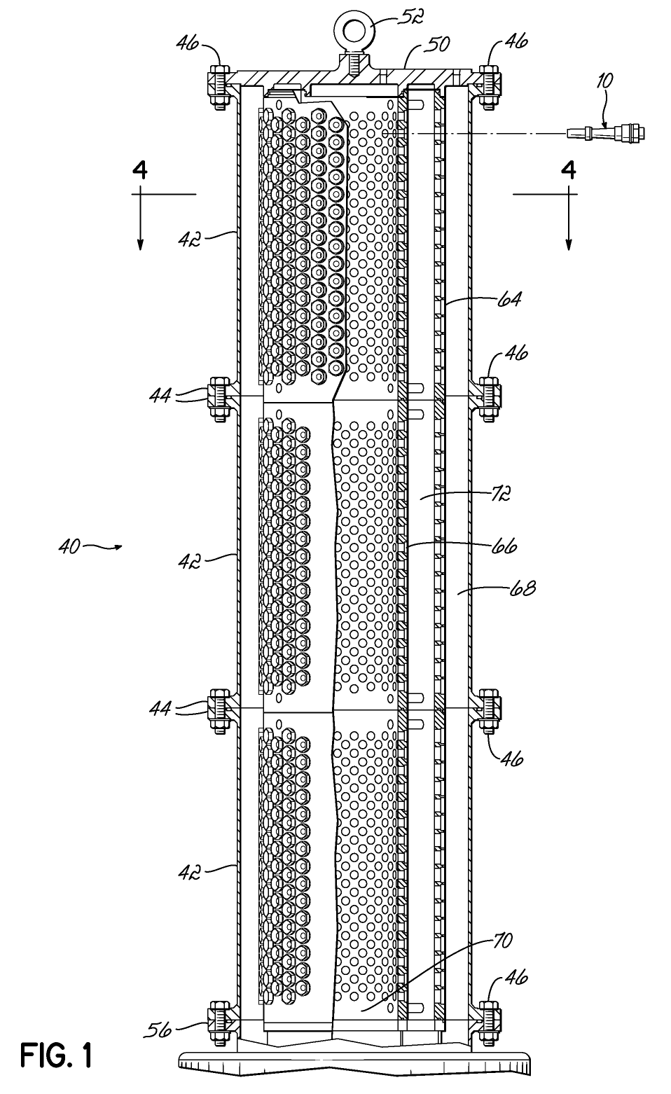

With reference now to FIG. 1 of the drawings, a housing 40 is shown comprising cylinders 42, each having outwardly projecting annular flanges 44 to permit two or more cylinders 42 to be clamped together by bolts 46 to form a continuous, outer, annular chamber 68. While three cylinders 42 are shown in FIG. 1 of the drawings, it will be apparent that more or less cylinders may be employed, depending on the desired length of the annular outer chamber. At its upper end, the annular outer chamber is capped by a closure plate 50 having a lifting ring 52. The closure plate 50 is clamped to the upper end of the uppermost cylinder 42 in a manner similar to the clamping between adjacent cylinders by means of bolts 46.

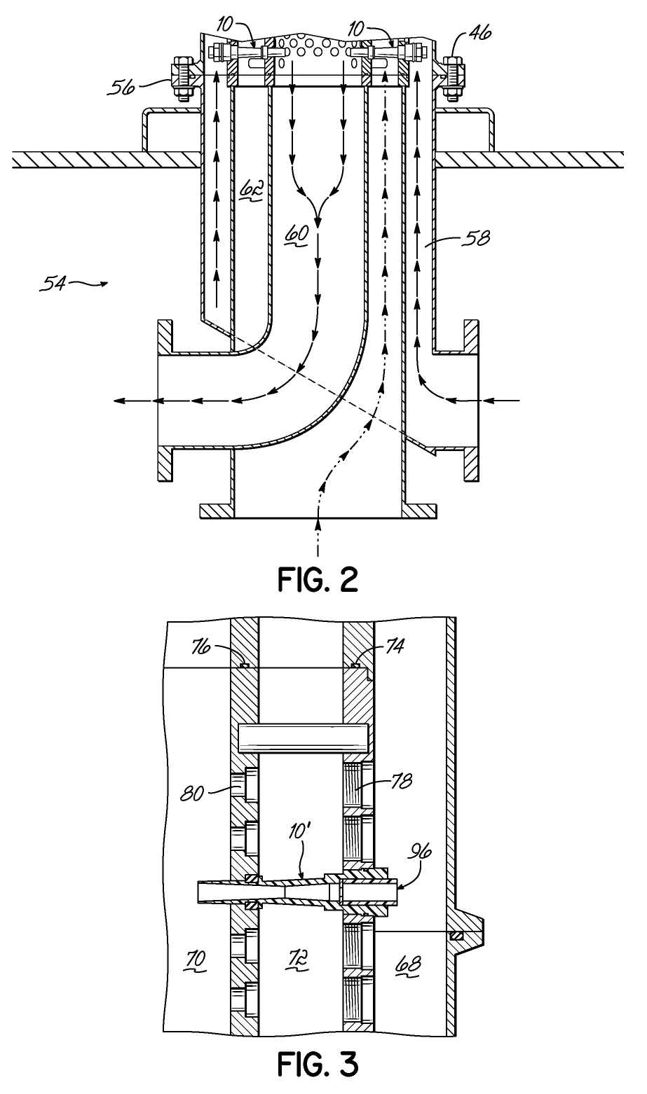

With reference now to FIGS. 1 and 2 of the drawings, it will be seen that the lowermost cylinder 42 is attached at its lower end by means of bolts 46 to a manifold system 54. At its upper end, the manifold system 54 has an outwardly projecting annular flange 56 to which the lower most cylinder 42 is clamped by the bolts 46 as shown in FIG. 2 of the drawings. The manifold system 54 comprises three concentric flow channels, namely, an outer feed channel 58, a central, outwardly-flowing channel 60, and an intermediate channel 62, which may or may not be used during the practice of the present invention, as will be described in more detail.

As seen in FIG. 1 of the drawings, positioned concentrically within the outer cylinders 42 are intermediate cylinders 64 and inner cylinders 66, which are each superimposed upon each other and clamped by the clamping action between the outer cylinders, the top plate 50 and the lower annular rim 56 of the manifold system 54. It will thus be apparent with reference to FIGS. 1 and 2 of the drawings that the outer and intermediate cylinders form the annular outer chamber 68 communicating with the outer feed manifold 58, an inner or central chamber 70, communicating with the manifold 60, and an intermediate chamber 72 communicating with the manifold 62.

As best seen in FIG. 3 of the drawings, adjoining sets of intermediate and inner cylinders may be provided with annular grooves 74 and 76 to receive any convenient sealing means. Intermediate cylinders 64 are also provided with closely spaced openings 78 to receive cyclonettes which may be of more or less conventional design of a type shown in FIG. 6 of the drawings or of various modified forms which will be described presently in more detail. In any case, the cyclonettes are secured in any convenient manner in the openings 78 with the opposite ends of the cyclonettes being received in openings 80 in the cylinders 66. In FIG. 3 of the drawings the openings 78 are shown as having internal threads, which could receive complementary external threads on the exterior of the cyclonettes. In this regard, O-rings, such as those shown at 16 and 20 in FIG. 6 of the drawings, may be utilized to create seals with the cylinders 64 and 66, respectively.

However, the particular manner of securing the cyclonettes in the intermediate and interior cylinders 64 and 66 does not form a part of the present invention, and any convenient means may be utilized. In any case, the positioning of a cyclonette, regardless of its specific configuration, in the manner shown in FIG. 3 permits the liquid delivered through the outer manifold 58 and into the annular outer chamber 68 to flow into an insert 82 and then into the upstream end of the cyclonette and out its downstream end where it is immersed in the liquid being treated, which is being collected in the inner or central cylindrical chamber 70 and then out through the manifold 60.

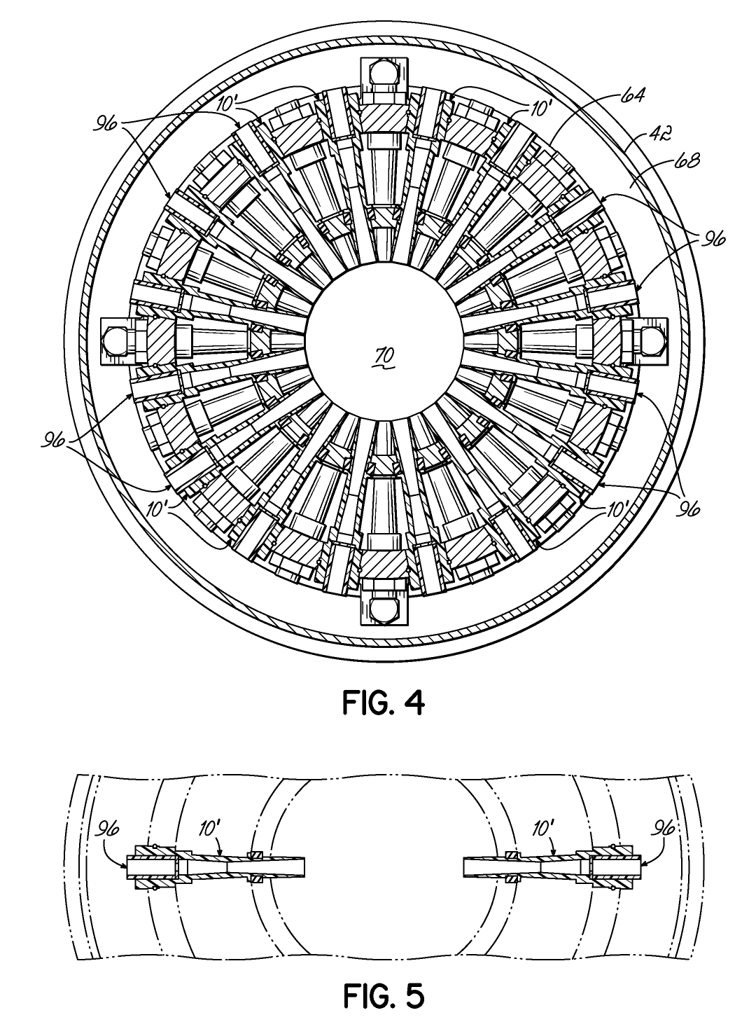

As seen in FIGS. 1 and 4 of the drawings, it is contemplated by the present invention that hundreds, perhaps even a thousand or more of cyclonettes, will be arrayed in a single housing 40. Preferably, each cyclonette, as depicted at 10′ in FIG. 5 of the drawings, is disposed opposite another, resulting in direct impingement of the flow from one cyclonette upon the opposite flow from an opposing cyclonette.

As indicated, previous, conventional utilization of a cyclonette and vortex finder insert as shown in U.S. Pat. No. 5,388,708, for example, would result in flow, with reference to FIG. 2 of the drawings, into the intermediate manifold 62 and thence, with reference to FIG. 1, into the intermediate chamber 72. From there the flow would pass into the passageway 36 as seen in FIG. 6 of the drawings, and then spiral around the surface of the throat 22 and thereafter, around the surface of the tapered flow channel 24 to the right as seen in FIG. 6 of the drawing. This would set up a counter flow to the left as seen in FIG. 6 and out the vortex finder 12 of the fines fraction of the suspension while the heavier fractions of the suspension passed on out the narrower flow channel 26 of the cyclonette.

In contrast, in accordance with the present invention, the feed flow in manifold 58, as shown in FIG. 2 of the drawings, is just the opposite of conventional operation. That is, instead of accepting the fines in an outward flow, the manifold 58 is in fact the feed manifold for the system, delivering the liquid to be treated to the upstream or left-hand end of the vortex finder, as shown in FIG. 6 of the drawings, from whence the flow is ejected in an axial jet out the extension 34 of the vortex finder and into the tapering flow channel 24. This action results in the generation of shear zones that create a myriad of tiny bubbles, each of which, upon implosion, create highly localized areas of extreme pressures and temperatures.

This in turn results in a dissolution of the water molecules into, inter alia, aggressive hydroxyl radicals. While in its most straightforward form the passageway 36 in the upstream end of the cyclonette will not be utilized, in a modification of the basic form of the invention, a supply of the liquid being treated may be fed via the intermediate manifold 62 and the intermediate chamber 72 into the passageways 36 to provide an additional flow and hence an intensifying of the shear zone to enhance the formation of the tiny bubbles as liquid flows through the tapering flow channel 24 of the cyclonette 10.

Depending upon the desired effect, the passageway 36 may be disposed tangentially with respect to the throat 22, radially, or even substantially axially. It should also be noted that, in addition to utilizing the passageway 36 for the supplemental flow of the liquid being treated, different fluids, gaseous or liquid, could be injected through the passageway 36 to alter the physical or chemical character of the liquid being treated. For example, a pH-adjusting fluid could be supplied through the passageway 36.

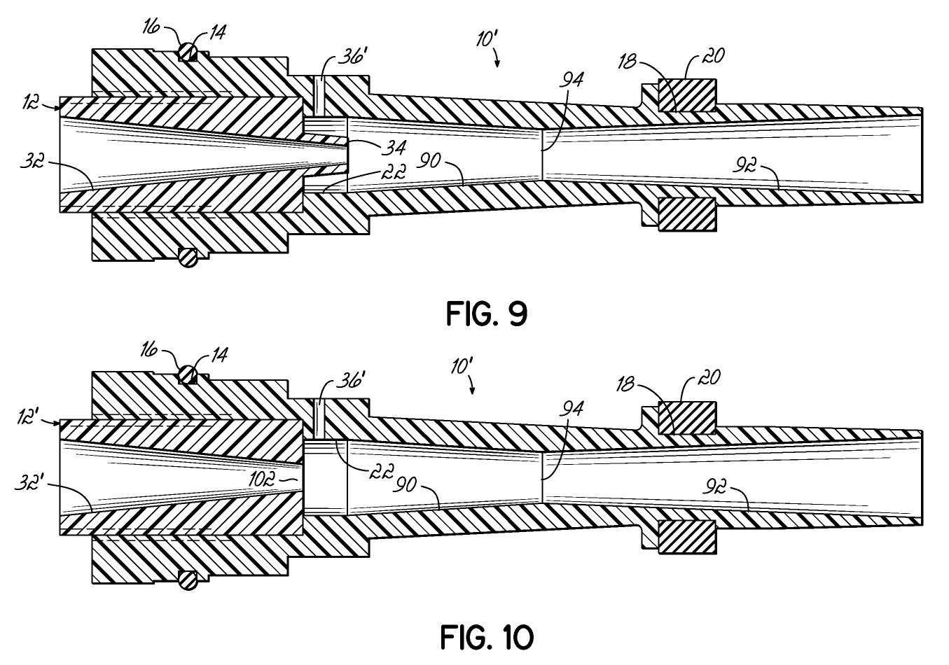

FIG. 9 of the drawings shows a cyclonette 10′, similar to that of FIG. 6, but with the flow channels 24 and 26 replaced by flow channels 90 and 92. The reduced diameter at point 94 results in an increase in velocity and a corresponding reduction in static pressure. The pressure within the chamber is directly related to the velocity head at this point. The outwardly tapering flow channel 92 results in a gradual decrease in fluid velocity, permitting efficient conversion of velocity head into static head as the fluid moves toward the discharge zone.

As seen in FIG. 10 of the drawings, a cyclonette 10′ is provided, but the vortex finder 12 of FIGS. 6 and 9 of the drawings, is replaced by vortex finder 12′ in which the extension 34 protruding into the throat portion 22 is eliminated. As a result, the immediate transition from the downstream end of the modified vortex finder 12′ into the larger diameter throat portion 22 provides an additional shear zone for the generation of the desirable fine bubbles.

In yet another modification of the hydraulic cavitation device of the present invention, as shown in FIG. 7, the cyclonette 10′ is combined with an insert 96 having a straight sided internal bore 98 and external threads 99, which are complementary to internal threads 28′ in the modified cyclonette 10′. The insert 96 captures and holds in place within the cyclonette 10′ a washer-shaped orifice plate 100 having a central orifice 102. This embodiment has shown to be most productive in the formation of multiple tiny bubbles, as the liquid being treated must first constrict from the larger diameter of the insert flow passage 98 to the restricted orifice 92 and then expand again into the throat 22 of the cyclonette 10′. In this embodiment, as in those of FIGS. 9 and 10, the passageway 36 may be used for the addition of a flow of the liquid being treated or a chemical or physical modifying substance in either a tangential, radial or substantially axial direction into the throat 22 of the cyclonette 10 or 10′.

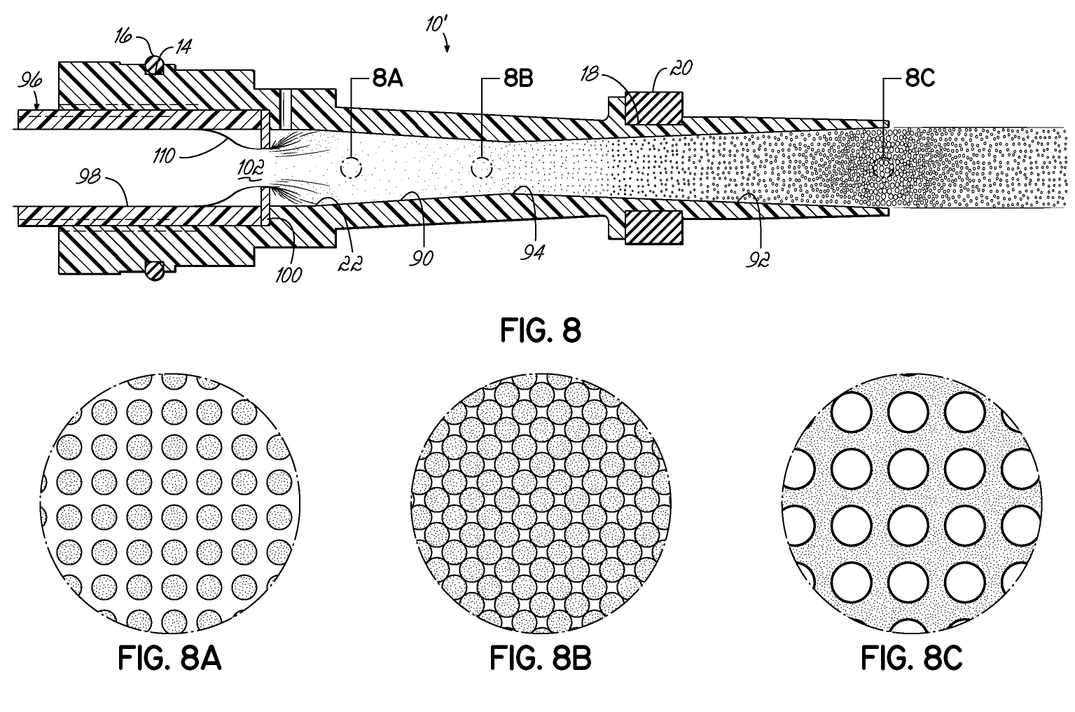

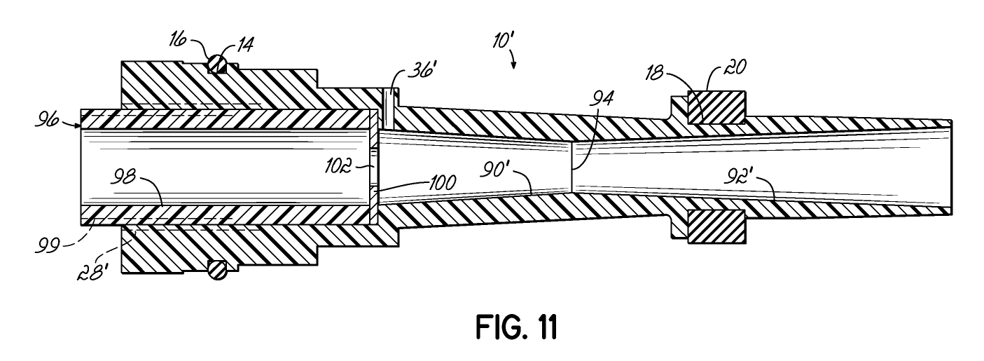

In some cases, it may be found desirable to eliminate the throat 22, as shown in FIG. 11 of the drawings, and convey the flow through the orifice 102 directly into an inwardly tapered flow channel 90′ and then outwardly into the radially outwardly tapering flow channel 92. In this embodiment, as in the embodiments of FIGS. 7 and 8, the orifice plate 100 is held in place in the cyclonette 10′ by the insert 96, which permits orifice plate 100 to be easily replaced for wear or the like.

Turning now to FIGS. 8, 8A, 8B and 8C, it will be seen that a liquid 110 being delivered to the upstream end of a modified cyclonette 10′, via the outer manifold 58 and outer annular chamber 68, passes through an insert 96 and thence through the orifice 102 of the orifice plate 100 and into the throat portion 22. This creates an intense shear zone, resulting in a myriad of fine bubbles and droplets, some of which are dispersed at point 8A in the flow channel 90 as depicted diagrammatically in FIG. 8A. As the flow proceeds downstream through the ever-narrowing flow channel, the droplets move closer together and entrain pockets of vapor. Some of the kinetic energy of the liquid is utilized to accelerate and compress the pockets of vapor into bubbles until downstream flow channel 92 is reached. Beyond point 8B, as the fluid moves to a zone of lower pressure, the bubbles tend to expand. Lastly, at point 8C, the bubbles have assumed a size and configuration as shown in FIG. 8C of the drawings.

Thus, it will be seen that the cavitation-generating technology of the present invention utilizes a vacuum chamber maintained within the individual cyclonettes by immersing their discharge ends in the liquid being treated and directing a high velocity jet of the liquid being treated to pass through a volume of vapor to increase bubble formation once vacuum is achieved.

From the above, it will be apparent that the present invention provides an efficient method of harnessing the water molecule dissolution powers of hydraulic cavitation with the consequent release of aggressive hydroxyl radicals and highly effective liquid treatment. Additionally, the present invention utilizes conventional hydrocyclones and modifications thereof by operating them in a manner completely contrary to their intended purpose.

What is claimed is:

1. A hydraulic cavitation device for treating a body of liquid comprising:
a body including an upstream and a downstream end and an internal, unidirectional flow channel extending therethrough along an axis of the body from the upstream end to the downstream end, the body further including an orifice plate situated proximate the upstream end of the unidirectional flow channel and having an orifice defined therethough to allow for passage of liquid from the upstream end to the downstream end of the device, the orifice having a diameter smaller than that of the flow channel at the upstream end, the flow channel including a first portion downstream of the orifice plate that tapers inwardly in a downstream direction along the axis toward a second portion of the flow channel, the second portion tapering outwardly along the axis in a downstream direction toward the downstream end.

2. The device of claim 1 wherein the body further comprises an insert situated at the upstream end thereof adjacent the orifice plate, the insert having an opening extending therethrough along the axis to allow for passage of liquid from the upstream end, and through the orifice towards the downstream end of the device.

3. The device of claim 2 wherein the insert is removable.

4. The device of claim 2 wherein the insert has a constant internal diameter.

5. The device of claim 2 wherein the insert and the orifice plate define a monolithic structure.

6. The device of claim 1 wherein the orifice plate is positioned generally perpendicular to the axis.

7. The device of claim 1 wherein the body further comprises a passageway extending therethrough generally perpendicular to the axis.

8. The device of claim 1 wherein the flow channel further includes a throat portion of substantially constant internal diameter situated intermediate the orifice plate and the first portion of the flow channel.

9. The device of claim 8 wherein the body further comprises a passageway extending therethrough into the throat portion.

10. The device of claim 1 wherein the flow channel includes a minimum diameter point situated intermediate the first portion and the second portion.

11. A hydraulic cavitation device for treating a body of liquid comprising:
a body including an upstream and a downstream end and an internal, unidirectional flow channel extending therethrough along an axis of the body from the upstream end to the downstream end, the body including an orifice plate situated proximate the upstream end of the unidirectional flow channel and having an orifice defined therethough, the orifice having a diameter smaller than that of the flow channel at the upstream end, the body further including an insert situated at the upstream end thereof adjacent the orifice plate, the insert having an opening extending therethrough along the axis to allow for passage of liquid from the upstream end, and through the orifice towards the downstream end of the device.

12. The device of claim 11 wherein the insert is removable.

13. The device of claim 11 wherein the insert has a constant internal diameter.

14. The device of claim 11 wherein the insert and the orifice plate define a monolithic structure.

15. The device of claim 11 wherein the orifice plate is positioned generally perpendicular to the axis.

16. The device of claim 11 wherein the body further comprises a passageway extending therethrough generally perpendicular to the axis.

17. The device of claim 1 wherein the flow channel further includes a throat portion of substantially constant internal diameter situated intermediate the orifice plate and the first portion of the flow channel.

18. The device of claim 17 wherein the body further comprises a passageway extending therethrough into the throat portion.

19. The device of claim 11 wherein the flow channel includes a minimum diameter point situated intermediate the first portion and the second portion.

20. A method of treating a body of liquid comprising:
passing the liquid through a cyclonette that includes a body having an upstream and a downstream end and an internal, unidirectional flow channel extending therethrough along an axis of the body from the upstream end to the downstream end, the body further including an orifice plate situated proximate the upstream end of the unidirectional flow channel and having an orifice defined therethough to allow for passage of the liquid from the upstream end to the downstream end of the device, the orifice having a diameter smaller than that of the flow channel at the upstream end, the flow channel including a first portion downstream of the orifice plate that tapers inwardly in a downstream direction along the axis toward a second portion of the flow channel, the second portion tapering outwardly along the axis in a downstream direction toward the downstream end.

21. A method of treating a body of liquid comprising:
passing the liquid through a cyclonette that includes a body having an upstream and a downstream end and an internal, unidirectional flow channel extending therethrough along an axis of the body from the upstream end to the downstream end, the body including an orifice plate situated proximate the upstream end of the unidirectional flow channel and having an orifice defined therethough, the orifice having a diameter smaller than that of the flow channel at the upstream end, the body further including an insert situated at the upstream end thereof adjacent the orifice plate, the insert having an opening extending therethrough along the axis to allow for passage of liquid from the upstream end, and through the orifice towards the downstream end of the device.
